(19) United States
(12) Patent Application Publication
(10) Pub. No.: US 2005/0144564 A1
(43) Pub. Date: Jun. 30, 2005

(54) Device and method for adding header or footer to text message on a mobile terminal

(75) Inventor: Jae-Sung Shim, Anyang-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD, GYEONGGI-DO (KR)

(21) Appl. No.: 10/967,520

(22) Filed: Oct. 18, 2004

(30) Foreign Application Priority Data
Dec. 26, 2003 (KR) 97569/2003

(51) Int. Cl. G06F 3/00

(52) U.S. Cl. 715/764

(57) ABSTRACT

A device and a method for inputting a text message on a mobile terminal. The device includes: a user input section for allowing a user to input characters, select a menu or input a command; a memory including an additional comment storing section; a control section for determining whether a user inputs any additional comment after inputting a message through the user input section, reading the additional comment from the memory and inserting the additional comment to the input message to complete a text message to be sent; and a display section for displaying any input through the user input section. The method for inputting a text message on a mobile terminal comprises: inputting a message; determining whether a user wishes to add a comment to the input message; and inserting an additional comment stored in a memory to the input message to complete a text message to be sent.

### PRIORITY

This application claims priority to an application entitled “Device and Method for Adding Header or Footer to Text Message on Mobile Terminal” filed with the Korean Intellectual Property Office on Dec. 26, 2003 and assigned Serial No. 2003-97569, the contents of which are hereby incorporated by reference.

### BACKGROUND OF THE INVENTION

1. Field of the Invention

The present invention relates to a device and a method for inputting and sending a text message on a mobile terminal, and more particularly to a device and a method for adding a header or a footer to a message input by a user on a mobile terminal to complete a text message to be sent.

2. Description of the Related Art

Generally, when a person wishes to send a simple uniform text message to multiple recipients from a mobile terminal, he or she may use a multi-address messaging function. In such case, no additional comments for a specific recipient can be added to the uniform text message. For example, the user can prepare a text message “Hi! Have a nice day!” on the mobile terminal and forward the same message to multiple recipients. However, at present it is not possible to insert any additional comment to the multi-address message individually for each recipient.

### SUMMARY OF THE INVENTION

Accordingly, the present invention has been made to solve the above-mentioned problems occurring in the prior art, and one object of the present invention is to provide a device and a method for adding a comment for each recipient to a multi-address text message input on a mobile terminal.

Another object of the present invention is to provide a device and a method for adding a stored header or footer to a message input on a mobile terminal, thereby completing a text message to be sent.

In accordance with one aspect of the present invention for accomplishing the above objects, there is provided a device for inputting a text message on a mobile terminal, including: a user input section for allowing a user to input characters, select a menu or input a command; a memory including an additional comment storing section; a control section for determining whether a user inputs any additional comment after inputting a message through the user input section, reading the additional comment from the memory and inserting the additional comment to the input message to complete a text message to be sent; and a display section for displaying any input through the user input section.

In accordance with another aspect of the present invention, there is provided a method for inputting a text message on a mobile terminal, comprising: inputting a message; determining whether a user wishes to add a comment to the input message; and inserting an additional comment stored in a memory to the input message to complete a text message to be sent.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a structure of a mobile terminal according to the present invention;

FIG. 2 is a flow chart of a process of inputting a header or a footer according to the present invention;

FIG. 3 is a flow chart of a process of adding a header or a footer to a text message according to the present invention;

FIGS. 4A and 4B are diagrams of items contained in the “phone book” menu of a mobile terminal and sub-items displayed when an item is selected; and

FIGS. 5A to 5E are diagrams of items contained in the “sent messages” menu of a mobile terminal and sub-items displayed when an item is selected according to the present invention.

### DETAILED DESCRIPTION OF THE PREFERRED EMBODIMENT

Hereinafter, a preferred embodiment of the present invention will be described with reference to the accompanying drawings. Although certain elements, such as a greeting word ‘Dear’, are specifically defined in the following description of the present invention, it will be obvious to those skilled in the art that such definitions of elements are merely to improve understanding of the present invention and that the present invention can be carried out without such specific elements. Also, in the following description of the present invention, a detailed description of known functions and configurations incorporated herein will be omitted when it may make the subject matter of the present invention unclear.

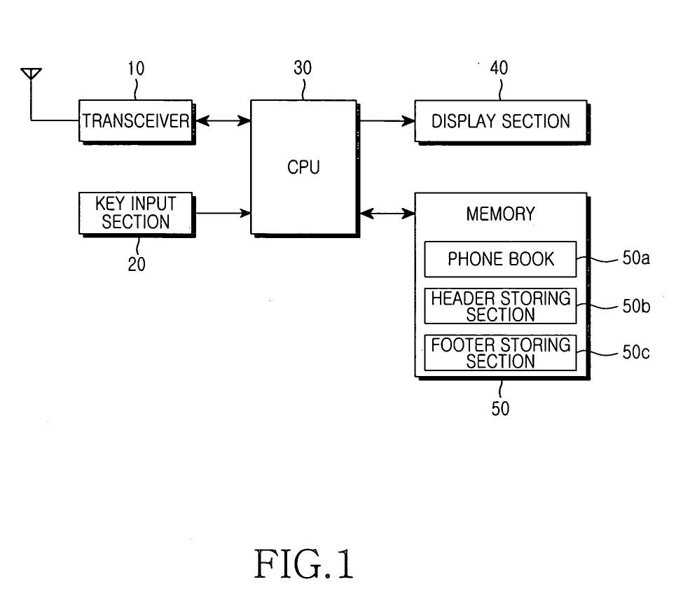

FIG. 1 shows the structure of a mobile terminal according to the present invention. A transceiver 10 is a processor for transmitting or receiving radio signals. A key input section 20 is a user input section provided with keys for inputting numbers or characters and function keys for setting up various functions. A user can input a telephone number or a text message using those keys. A central processing unit (CPU) 30 directs the overall operations of the mobile terminal. As a user interface means, a display section 40 may comprise an LCD device. The user can see any received message or the operational state of the mobile terminal through the display section 40. A memory 50 includes a telephone number storing section 50a, a header storing section 50b and a footer storing section 50c. Such a plurality of storing sections can be included in a single memory or provided on separate memories. The CPU 30 reads an additional comment, i.e., a header or a footer, from the memory 50 automatically in a preset mode or in response to the user's request input through the key input section 20, and adds the header or footer to a text message input by the user.

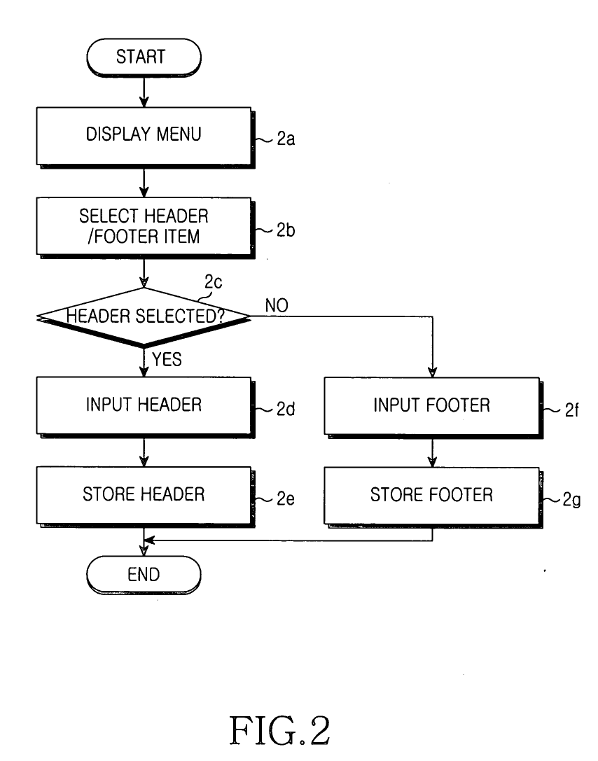

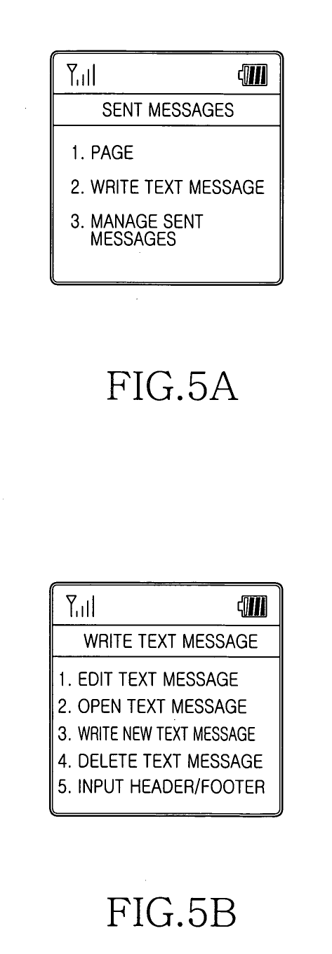

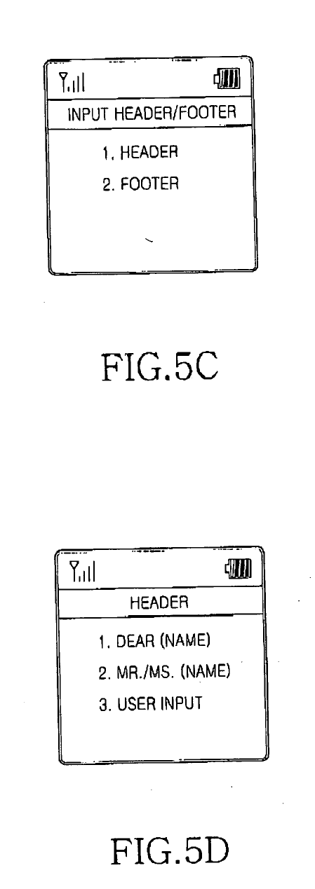

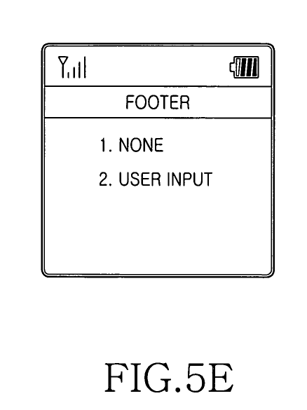

FIG. 2 is a flow chart showing a process of inputting a header or a footer according to the present invention. To activate the process, it is assumed that the user has pressed a menu key and selected an item to display sub-items for inputting a header or a footer. At step 2a, the CPU 30 recognizes the input of the menu key and directs the display section 40 to display the items contained in a selected menu, for example, as shown in FIG. 5A. If the user selects one item, for example, the item “2. Write a Text Message” (FIG. 5A), the display section 40 will display sub-items of the selected item as shown in FIG. 5B. If the user selects the item “5. Input a Header/Footer” (FIG. 5B), the CPU 30 will recognize the selection at step 2b and will determine whether the user wishes to input a header or a footer at step 2c. To this end, the CPU 30 directs the display section 40 to display sub-items as shown in FIG. 5C. If the user inputs a header at step 2d after selecting the item “1. Header” (FIG. 5C), the input header will be stored in the header storing section 50b of the memory 50 at step 2e. Sub-items for inputting a header may include those shown in FIG. 5D. Alternatively, the user may select the item “2. Footer” (FIG. 5C), and input a footer at step 2f. The input footer will be stored in the footer storing section 50c of the memory at step 2g. Sub-items for inputting a footer may include those shown in FIG. 5E.

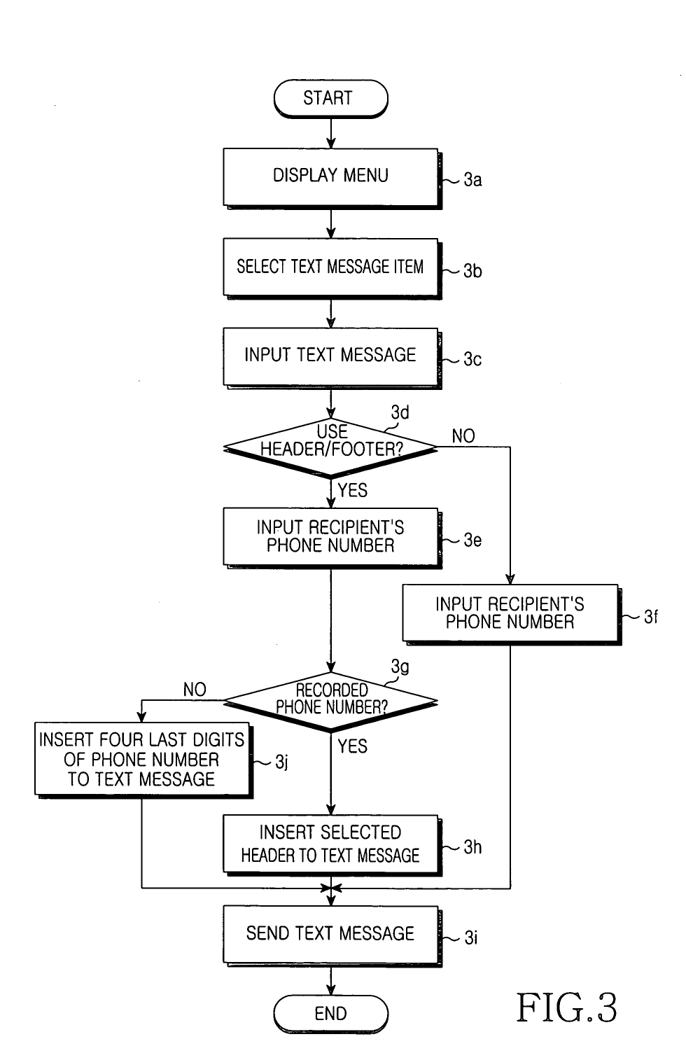

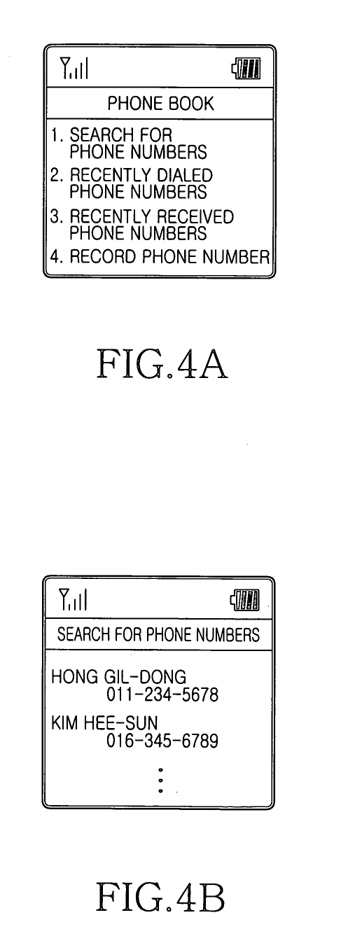

FIG. 3 is a flow chart showing a process of adding a header and/or a footer to a text message according to the present invention. FIGS. 4A and 4B are views showing items contained in the “phone book” menu and sub-items displayed when an item is selected. FIG. 4A shows items displayed when the user selects a phone book from initially displayed menus. If the user selects the item “1. Search Phone Numbers” from the displayed items, the picture as shown in FIG. 4B will be displayed. FIGS. 4A and 4B merely show examples of pictures displayed when the user selects a menu and an item contained in the menu. It is obvious that mobile terminals can have a variety of phone book forms according to the manufacturers or the years of manufacture.

FIGS. 5A to 5E showing items contained in the “sent messages” menu and sub-items displayed when an item is selected according to the present invention. FIG. 5A shows items contained in the “sent messages” menu. The items include paging, writing a text message and managing sent messages. In the preferred embodiment of the present invention, it is assumed that the user has selected the “write a text message” item. FIG. 5B shows sub-items, which include editing a text message, opening a text message, writing a new text message, deleting a text message and inputting a header/footer. The preferred embodiment of the present invention is applicable when the user selects opening a text message, writing a new text message or inputting a header/footer. The two items “open a text message” and “write a new text message” are generally selected to send a text message on the mobile terminal. The item “input a header/footer” can be selected when the user wishes to store a header or a footer in the memory in advance.

FIG. 5C shows two sub-items “header” and “footer” displayed when the “write a header/footer” item is selected. FIG. 5D shows sub-sub-items displayed when “header” is selected from the display of FIG. 5C. The user can select or directly input a word (ex. a honorific title word or greeting word, etc.), which should be given before the recipient's name. FIG. 5E shows sub-sub-items displayed when “footer” is selected from the display of FIG. 5C. The user can directly input any or no footer.

Hereinafter, a process for adding a header and/or a footer to a text message as shown in FIG. 3 will be explained in more detail with reference to the above described FIGS. 4A, 4B and 5A to 5E. It is assumed that the user has selected the “text message” menu by pressing a menu key. At step 3a, the CPU 30 recognizes the input of the menu key and directs the display section 40 to display items contained in the selected menu, for example, the menu shown in FIG. 5A. If the user selects an item, for example, “2. Write a Text Message,” the display section 40 will display sub-items of the selected item as shown in FIG. 5B.

If the user selects the items “2. Open a Text Message” or “3. Write a New Text Message,” the CPU 30 will recognize the selection at step 3b and will detect whether the user inputs a text message using a known function of opening a text message or writing a new text message at step 3c. At step 3d, the CPU 30 determines whether the user wishes to input a header or a footer. To this end, the CPU 30 may direct the display section 40 to display yes/no options for the user to select one. Alternatively, the CPU 30 may be configured to recognize the user's wish to input a header or a footer when a predetermined key is pressed. If the user selects the item “1. Header,” (FIG. 5C) he or she can then input a recipient's telephone number at step 3e. At this time, the user can input the telephone number through a phone book search or by direct pressing of number keys.

At step 3g, the CPU 30 determines whether the input telephone number is recorded in the phone book. For explanatory convenience, the recipient's name and telephone number “Hong Gil-Dong 011-234-5678” in FIG. 4B will be explained as an example. If the input telephone number is determined as being recorded in the phone book, the corresponding recipient's name will be added as a header to the text message at step 3h.

For example, if the text message input by the user at step 3c is “Hi! Have a nice day!,” the greeting word and the name of the recipient “Dear Hong Gil-Dong” will be added as the header to the input message to make a complete text message “Dear Hong Gil-Dong, Hi! Have a nice day!” The recipient's name “Hong Gil-Dong” is copied from the records of the phone book and a greeting word “Dear” is inserted according to the user's selection on the display as shown in FIG. 5D. The insertion of a title or a greeting word can make the recipient feel better when reading the text message.

If the input telephone number is determined as not being recorded in the phone book, the last four digits in the input telephone number will be inserted as a header to the text message at step 3j. The complete text message will then be “Dear 5678, Hi! Have a nice day!”

If the user selects the item “2. Footer” (FIG. 5C) at step 3d, he or she can input the recipient's telephone number again at step 3f. It is possible to insert a comment stored by the user in advance, for example, “Take care,” as a footer at the end of the input text message.

After completing steps 3f, 3h or 3j, the user can send a final, completed text message at step 3i.

FIG. 3 shows a process of inputting a telephone number of a single recipient in a text message. Although not shown in this drawing, it is possible to input telephone numbers of multiple recipients in a multi-address message at step 3e, using the header/footer inserting function. Steps 3g, 3h and 3i or steps 3g, 3j and 3i need be repeated according to the number of recipients. If neither a header nor a footer is added to a multi-address text message, the user needs to input only the telephone numbers of the multiple recipients at step 3f and repeat step 3i according to the number of the input telephone numbers.

As explained above, the present invention databases additional comments that can be added as a header or a footer to a text message, thereby improving user convenience. The user can add a header or a footer individually for each recipient when forwarding a uniform text message to multiple recipients. Accordingly, the present invention can reduce the trouble for the user to repeatedly input the same message to send it to multiple recipients and solve the monotony of a multi-address message by enabling the user to insert each recipient's name and title or greeting word to improve a sense of intimacy and add a certain comment for a certain recipient or a certain group of recipients.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

1. A device for inputting a text message on a mobile terminal, comprising:
a user input section for allowing a user to input characters, select a menu and input a command;
a memory including an additional comment storing section;
a control section for determining whether a user inputs any additional comment after inputting a message through the user input section, reading the additional comment from the memory and inserting the additional comment in to the input message to complete a text message to be sent; and
a display section for displaying any input through the user input section.

2. The device according to claim 1, wherein said additional comment is a header inserted at the beginning of said input message.

3. The device according to claim 2, wherein said display section displays sub-items for inputting the header, said sub-items including:
at least one item for selecting a word to be given before a recipient's name corresponding to a telephone number recorded in a phone book and automatically read from the phone book and inserted upon input of the telephone number; and
an item for user input.

4. The device according to claim 1, wherein said additional comment is a footer inserted at the end of said input message.

5. The device according to claim 4, wherein said display section displays sub-items for inputting a footer, said sub-items including a no-footer item and a user input item.

6. A method for inputting a text message on a mobile terminal, comprising:
inputting a message;
determining whether a user wishes to add a comment to the input message; and
inserting an additional comment stored in a memory to the input message to complete a text message to be sent.

7. The method according to claim 6, wherein said additional comment is a header inserted at the beginning of said input message.

8. The method according to claim 7, wherein said header includes a recipient's name corresponding to a telephone number recorded in a phone book and automatically read from the phone book and inserted upon input of the telephone number.

9. The method according to claim 8, wherein said header further includes a word input in advance by the user to be inserted before the recipient's name.

10. The method according to claim 7, wherein said header is directly input by the user and is stored in the memory.

11. The method according to claim 6, wherein said additional comment is a footer inserted at the end of said input message.

12. The method according to claim 11, wherein said footer is directly input by the user and is stored in the memory.
